(19) United States
(12) Patent Application Publication
(10) Pub. No.: US 2021/0053361 A1
(43) Pub. Date: Feb. 25, 2021

(54) DROP SEQUENCES DEFINING DIFFERENT MAPPINGS FOR DIFFERENT COLORANTS

(71) Applicant: HEWLETT-PACKARD DEVELOPMENT COMPANY, L.P., Spring, TX (US)

(72) Inventors: Juan SAEZ GOMEZ, Sant Cugat del Valles (ES); Michel GEORGES ENCRENAZ, Sant Cugat del Valles (ES); Fernando CHICA AGUILERA, Sant Cugat del Valles (ES)

(73) Assignee: Hewlett-Packard Development Company, L.P., Spring, TX (US)

(21) Appl. No.: 16/978,488

(22) PCT Filed: Mar. 29, 2018
(86) PCT No.: PCT/US2018/025194

§ 371 Date: Sep. 4, 2020

(51) Int. Cl. B41J 2/21; B41J 29/393; B41J 2/045

(52) U.S. Cl. CPC B41J 2/2114; B41J 2/2146; B41J 2/04581; B41J 29/393

(57) ABSTRACT

A first input color channel value for a first colorant and a second input color channel value for a second colorant are received. A first number of drops of a first colorant is obtained based on the first input color channel value and a first drop sequence. A second number of drops of a second colorant is obtained based on the second input color channel value and a second drop sequence. The first drop sequence defines a first mapping between input color channel values and number of drops and the second drop sequence defines a second, different, mapping between input color channel values and number of drops.

### BACKGROUND

Many 2D or 3D printers operate by depositing drops of printing liquid onto substrates. Examples include thermal inkjet printers and piezoelectric inkjet printers. Each pixel of a printed image may use drops of different printing liquids. For example, in a printer containing multiple colorants a pixel may use drops from more than one colorant in order to achieve a certain color. A colorant may be a printing liquid that is deposited onto a substrate to produce a particular color, and drops of multiple colorants may be used to produce a range of colors on the substrate. The number of drops for each colorant may be determined using a drop sequence that maps input color channel values to output number of drops. That is, the input color channel values of a pixel define the color of that pixel in the input image, and the drop sequence may be used to convert from the continuous scale of the input color channel values to a number of drops of each colorant in order to form the color defined by the input color channel values in the corresponding pixel of the substrate. A low input color channel value for a colorant in a pixel may correspond to a light shade of the corresponding color in that pixel or low presence of that color in the mix of colors that make up the color of the pixel. Consequently, the drop sequence may define a low number of drops for a low input color channel value. A high input color channel value for a colorant in a pixel may correspond to a dark shade of the corresponding color in that pixel or high presence of that color in the mix of colors that make up the color of the pixel. Consequently, the drop sequence may define a high number of drops for a high input color channel value.

### BRIEF INTRODUCTION OF THE DRAWINGS

Examples are further described hereinafter with reference to the accompanying drawings, in which:

FIG. 1 shows a print head according to an example of the disclosure;

FIG. 2 shows a printer according to an example of the disclosure;

FIG. 3 shows a method according to an example of the disclosure;

FIG. 4 shows a graph of drop sequences mapping input color channel values to discrete numbers of drops according to an example of the disclosure;

FIG. 5 shows a graph of drop sequences mapping input color channel values to a continuous number of drops according to an example of the disclosure;

FIG. 6 shows a method according to an example of the disclosure;

FIG. 7 shows a method for calculating drop sequences according to an example of the disclosure; and

FIG. 8 shows a graph of chroma value against number of drops according to an example of the disclosure.

### DETAILED DESCRIPTION

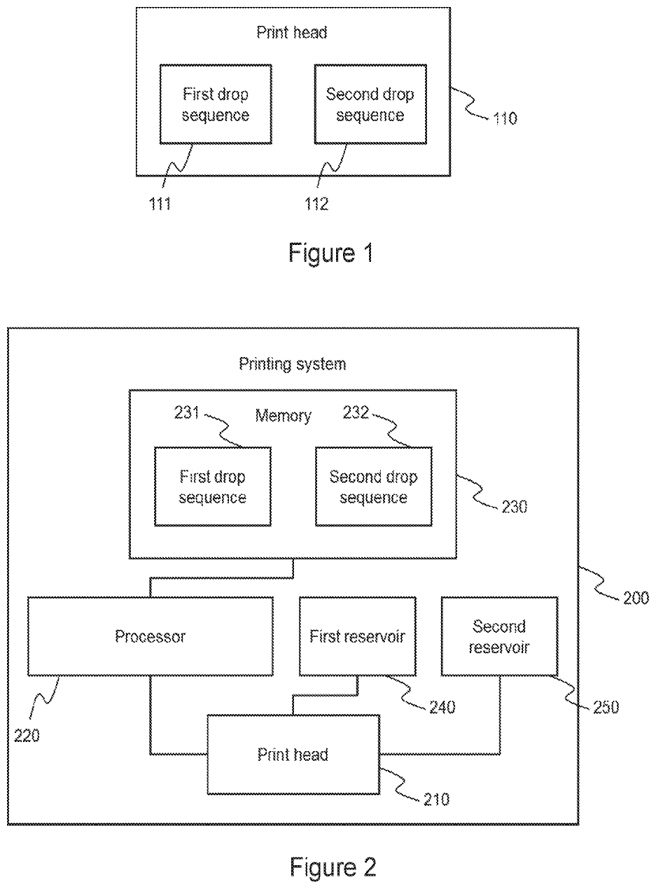

FIG. 1 shows a print head 110 according to an example of the disclosure. The print head 110 may transfer two or more colorants from respective reservoirs to a substrate according to respective drop sequences. That is, the print head 110 may transfer a first colorant from a first reservoir to a substrate according to a first drop sequence, to transfer a second colorant from a second reservoir to a substrate according to a second drop sequence, and so on. It will be appreciated that any number of colorants and respective reservoirs and drop sequences may be used. Each drop sequence may define a mapping between an input color channel value and an output number of drops of the colorant. That is, a first drop sequence may define a first mapping between an input color channel value and an output number of drops of colorant, a second drop sequence may define a second mapping between an input color channel value and an output number of drops of colorant, and so on. A first drop sequence for a first colorant may define a different mapping to a second drop sequence for a second colorant. That is, at least one drop sequence may define a different mapping between input color channel values and output number of drops of colorant to at least one other drop sequence. In other words, the print head 110 may not use the same drop sequence for every colorant.

FIG. 1 illustrates the print head 110 comprising a first drop sequence 111 and a second drop sequence 112. The first drop sequence 111 and second drop sequence 112 may be in a memory or circuitry of the print head 110 and the print head 110 may receive input color channel values for each colorant and convert the input color channel values to an output number of drops using the respective drop sequences. It will be appreciated that this is merely an example, and that the print head 110 may not comprise the drop sequences. For example, the drop sequences may be stored elsewhere, in software or hardware, and the print head 110 may receive as an input a number of drops for each colorant, the input number of drops having already been converted elsewhere from input color channel values based on respective drop sequences. For example, the conversion may be performed by a processor of a printer or a local or remote computing device that may communicate with the printer or print head 110. In some examples, the drop sequences may be created by the manufacturer and uploaded to firmware. For instance, this may be stored in a suitably formatted text file in a printer hard disk drive, and made available to the print head 110. In some examples, a number of predetermined drop sequences may be included in the firmware from which the manufacturer or user may select, or from which a suitable drop sequence may be automatically selected, based on a measurement or other factors. As a further example, the drop sequence for each colorant may be determined by the print head or associated equipment at the time of printing, according to the considerations set out below. It will be appreciated that these are merely examples, and that the drop sequences may be created, stored, and selected in any suitable way.

The memory of the printer or local or remote computing device may comprise a non-transitory machine readable storage medium encoded with instructions executable by a processor, the machine readable storage medium comprising: instructions to use a first drop sequence to convert a first input color channel value to a first output number of drops for a first colorant; and instructions to use a second drop sequence to convert a second input color to a second output number of drops for a second colorant; wherein the first drop sequence defines a first mapping between input color channel values and number of drops and the second drop sequence defines a second, different, mapping between input color channel values and number of drops. As described above, the memory and processor may be components of the print head 110, the printer, or a local or remote computing device that may communicate with the printer or print head 110.

FIG. 2 shows a printing system according to an example of the disclosure. The printing system 200 of FIG. 2 comprises a print head 210 as described above to transfer two or more colorants from respective reservoirs to a substrate according to respective drop sequences, each drop sequence defining a mapping between an input color channel value and an output number of drops of the colorant. The printing system may comprise reservoirs containing colorants. For example, the printer may comprise a first reservoir 240 to contain a first colorant, and a second reservoir 250 to contain a second colorant. Each of the reservoirs may couple to the print head and to supply the stored colorant to the print head 210. A first drop sequence for the first colorant may define a different mapping to a second drop sequence for the second colorant. In some examples, the printer 200 may comprise a processor 220 and memory 230. The skilled person will appreciate that a printer 200 may comprise a number of other known components of which a description here is omitted. In some examples, drop sequences may not be stored in the print head 210 and the memory 230 may store drop sequences such as a first drop sequence 231 and a second drop sequence 232.

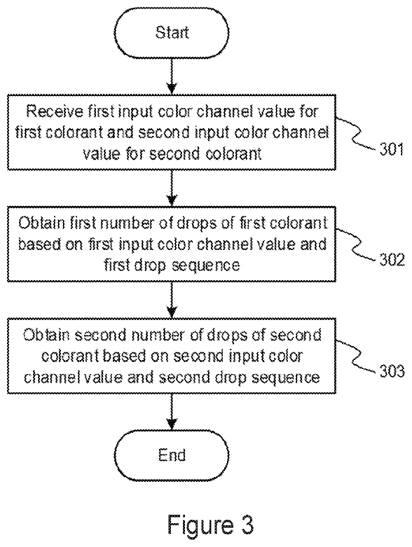

FIG. 3 shows a method according to an example of the disclosure. At 301 a first input color channel value for a first colorant and a second input color channel value for a second colorant may be received. At 302 a first number of drops of a first colorant may be obtained based on the first input color channel value and a first drop sequence. At 303 a second number of drops of a second colorant may be obtained based on the second input color channel value and a second drop sequence. The first drop sequence may define a first mapping between input color channel values and number of drops and the second drop sequence may define a second, different, mapping between input color channel values and number of drops. In other words, the method may not use the same drop sequence for every colorant.

In some examples, a drop sequence may comprise a breakpoint table for performing halftoning. The breakpoint table may map input color channel values to halftone levels. For example, the breakpoint table may map input color channel values on a scale of 0-255 to four halftone levels 0, 1, 2, and 3. The drop sequence may further comprise a mask to split the halftone levels between different print passes and associate a specific number of drops for each halftone level. For example, a drop sequence DS-1-4-8 may comprise a mask defining zero drops for halftone level 0, one drop for halftone level 1, four drops for halftone level 2, and eight drops for halftone level 3. A first drop sequence for a first colorant may comprise a different breakpoint table and/or a different mask from a second drop sequence for a second colorant. It will be appreciated that this is merely an example, and that the drop sequence may comprise any suitable mapping between input color channel values and output number of drops.

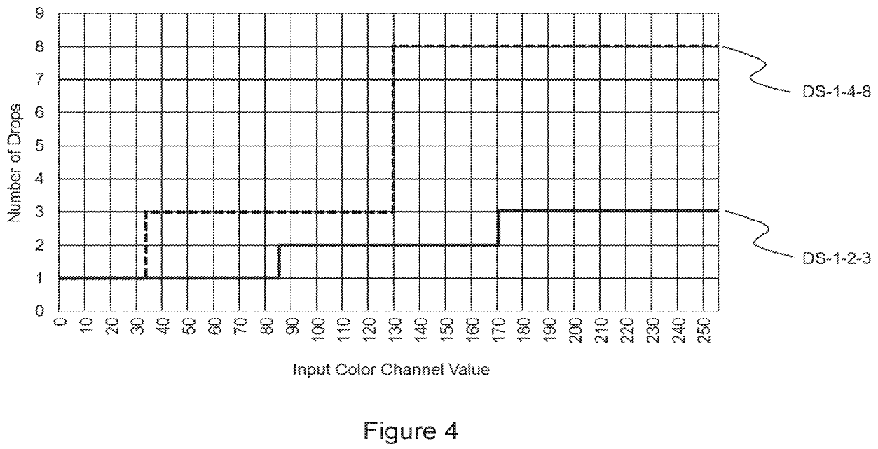

FIG. 4 shows a graph of drop sequences mapping input color channel values to discrete numbers of drops according to an example of the disclosure. Each drop sequence may define an output number of drops for a plurality of input color channel value ranges. Each drop sequence may define a different mapping between input color channel values and number of drops. The input color channel value for each colorant may be a value in the range of 0-255, but it will be appreciated that this is merely an example and that any scale or range of input color channel values may be used. An increased input color channel value may correspond to an increased intensity of that colorant. In some examples, a first drop sequence may define a first maximum number of drops, and a second drop sequence may define a second maximum number of drops that is greater than the first maximum number of drops. For example, in FIG. 4, a first drop sequence DS-1-2-3 defines zero drops for an input color channel value of zero, one drop for input color channel values in the range 1 to 85, two drops for input color channel values in the range 86 to 170, and three drops for input color channel values in the range 171 to 255. That is, if a pixel is assigned an input color channel value between 1 and 85 for a first colorant that uses first drop sequence DS-1-2-3, the print head may deliver one drop of the first colorant to that pixel on the substrate, or two drops for a input color channel value between 86 and 170, or three drops for a input color channel value between 171 and 255. The maximum number of drops for the first drop sequence in this example is three drops.

A second drop sequence DS-1-4-8 defines zero drops for an input color channel value of zero, one drop for input color channel values in the range 1 to 32, four drops for input color channel values in the range 33 to 128, and eight drops for input color channel values in the range 129 to 255. That is, if a pixel is assigned an input color channel value between 1 and 32 for a second colorant that uses second drop sequence DS-1-4-8, the print head will deliver one drop of the second colorant to that pixel on the substrate, or four drops for a input color channel value between 33 and 128, or eight drops for a input color channel value between 129 and 255. The maximum number of drops for the second drop sequence in this example is eight drops.

In the case that a first colorant uses first drop sequence DS-1-2-3 and a second colorant uses second drop sequence DS-1-4-8, the same input color channel value for the first colorant and the second colorant may therefore result in a different number of drops. For example, if the input color channel value is 60 for the first colorant and 60 for the second colorant, one drop of the first colorant may be output based on first drop sequence DS-1-2-3 whereas four drops of the second colorant may be output based on second drop sequence DS-1-4-8.

A suitable drop sequence may therefore be defined for each colorant. Some colorants may use fewer drops because they achieve a maximum value of a parameter after a small number of drops. For example, a first colorant may achieve a maximum chroma value with three drops, and a second colorant may achieve a maximum chroma value with eight drops. A first drop sequence DS-1-2-3 with a maximum of three drops may not be suitable for use with the second colorant because the maximum chroma value (requiring eight drops) would not be achievable. A maximum input color channel value of 255 would result in an output of three drops of colorant, which would not achieve the maximum chroma value. Second drop sequence DS-1-4-8 with a maximum of eight drops may be more suitable for the second colorant since it allows the maximum chroma value to be reached for each pixel. Conversely, second drop sequence DS-1-4-8 may be less suitable for the first colorant that achieves maximum chroma value with three drops since it is not possible to use two drops with DS-1-4-8. First drop sequence DS-1-2-3 may be more suitable for use with the first colorant since intermediate chroma values between the value achieved by use of one drop and the maximum chroma value (by use of three drops or more) are achievable by using two drops.

In some examples, a first drop sequence with a smaller number of maximum drops than a second drop sequence with a greater number of maximum drops may be assigned to a light colorant. The term “light colorant” indicates a colorant that is light relative to at least one other colorant being used. That is, a first drop sequence for a first colorant may define a first maximum number of drops, and a second drop sequence for a second colorant may define a second maximum number of drops that is greater than the first maximum number of drops, wherein the first colorant is a lighter colorant than the second colorant. A light colorant may be a colorant that achieves a maximum value of a parameter with a small number of drops relative to other colorants, as described above. For light colorants, using more drops may not necessarily improve the printed color. Using more drops may therefore be a less efficient use of colorant. One effect achieved by the different drop sequences is therefore more efficient use of colorants. For example, a printer or print head may use contain six colorants: cyan (C), light cyan (c), magenta (M), light magenta (m), yellow (Y), and black (K). The CMYK colorants may use a second drop sequence allowing a higher maximum number of drops than a first drop sequence used for the light cm colorants. For example, the CMYK colorants may use a second drop sequence DS-1-4-8 and the light cm colorants may use a first drop sequence DS-1-2-3. It will be appreciated that these are merely examples, and any number of colorants with any number of respective drop sequences may in principle be used. Furthermore, it will be appreciated that the drop sequences illustrated in FIG. 4 are merely examples, and that any mapping of any range of input color channel values to number of drops may in principle be used.

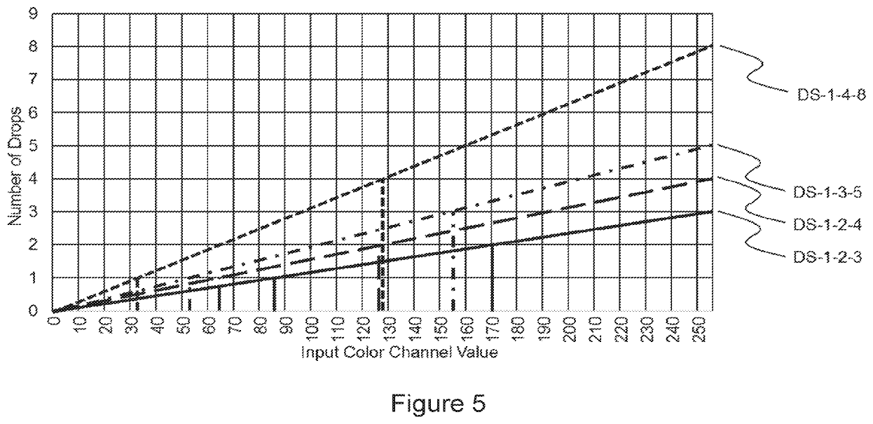

FIG. 5 shows a graph of drop sequences mapping input color channel values to a continuous number of drops according to an example of the disclosure. Drop sequences DS-1-2-3 and DS-1-4-8 are shown, corresponding to the drop sequences in FIG. 4. In addition, FIG. 5 includes drop sequence DS-1-2-4 and drop sequence DS-1-3-5. It will be appreciated that these are merely examples. As described above, a drop sequence may define, for example, three levels of drops as well as one zero-drop level. It will be appreciated that any number of levels could, in principle, be defined by a drop sequence, depending on the system resources, and the number of levels may vary between the drop sequences assigned to different colorants. The boundaries of three levels are marked on FIG. 5 by vertical lines (the zero-drop level is not shown). For example, drop sequence DS-1-4-8 defines a first level comprising a range of input color channel values (1-32) that correspond to one drop, a second level comprising a range of input color channel values (33-128) that correspond to four drops, and a third level comprising a range of input color channel values (129-255) that correspond to 8 drops. For a colorant using drop sequence DS-1-4-8, each pixel may therefore contain zero drops, one drop, four drops, or eight drops.

As shown in FIG. 5, each drop sequence may also define a continuous mapping of input color channel values to number of drops. That is, as well as levels comprising ranges of input color channel values corresponding to discrete numbers of drops, such as one drop, four drops, and eight drops, each drop sequence may, for example define a continuous linear mapping between input color channel values and number of drops. In this case, although each individual pixel may contain a number of drops corresponding to one of the discrete levels, (e.g. no drops, one drop, four drops, or eight drops for drop sequence DS-1-4-8), the number of drops per pixel in an area may be calculated such that the average number of drops per pixel in the area corresponds to the number of drops defined by the continuous mapping. For example, an input color channel value of 16 for a colorant using drop sequence DS-1-4-8 may be assigned to an area of pixels. Referring to FIG. 5, an input color channel value of 16 corresponds to 0.5 drops using drop sequence DS-1-4-8. To achieve an average of 0.5 drops per pixel, half of the pixels in the area may therefore use one drop of the colorant while the other half use zero drops of the colorant. It will be appreciated that an area including gradual variations in lighter shades of a color may thus be difficult to print accurately with a colorant using a high drop sequence such as drop sequence DS-1-4-8, whereas such an area could be printed more accurately by using a colorant with a low drop sequence such as DS-1-2-3.

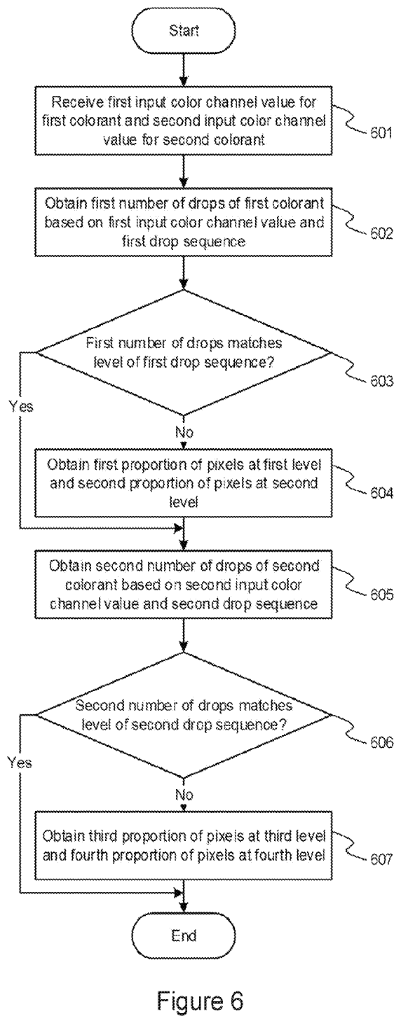

FIG. 6 shows a method according to an example of the disclosure. At 601 a first input color channel value for a first colorant and a second input color channel value for a second colorant may be received. At 602 a first number of drops of a first colorant may be obtained based on the first input color channel value and a first drop sequence. At 603 it may be determined if the first number of drops matches a number of drops corresponding to one of the levels of the first drop sequence. For example, if the first drop sequence is drop sequence DS-1-4-8, it may be determined if the first number of drops is one, four, or eight. If the first number of drops does not match a number of drops corresponding to one of the levels of the first drop sequence, the method may proceed to 604. At 604, a first proportion of pixels using a number of drops corresponding to a first level of the first drop sequence and a second proportion of pixels using a number of drops corresponding to a second level of the first drop sequence are obtained such that the average number of drops per pixel in the first and second proportions of pixels corresponds to the first number of drops. If the first number of drops matches a number of drops corresponding to one of the levels of the first drop sequence, the method may proceed to 605.

At 605 a second number of drops of a second colorant may be obtained based on the second input color channel value and a second drop sequence. The first drop sequence may define a first mapping between input color channel values and number of drops and the second drop sequence may define a second, different, mapping between input color channel values and number of drops. At 606 it may be determined if the second number of drops matches a number of drops corresponding to one of the levels of the second drop sequence. For example, if the second drop sequence is drop sequence DS-1-2-3, it may be determined if the second number of drops is one, two, or three. If the second number of drops does not match a number of drops corresponding to one of the levels of the second drop sequence, the method may proceed to 607. At 607, a third proportion of pixels using a number of drops corresponding to a third level of the second drop sequence and a fourth proportion of pixels using a number of drops corresponding to a fourth level of the second drop sequence are obtained such that the average number of drops per pixel in the third and fourth proportions of pixels corresponds to the second number of drops. It will be appreciated that the method of 605 to 607 may be performed in parallel to the method of 602 to 604.

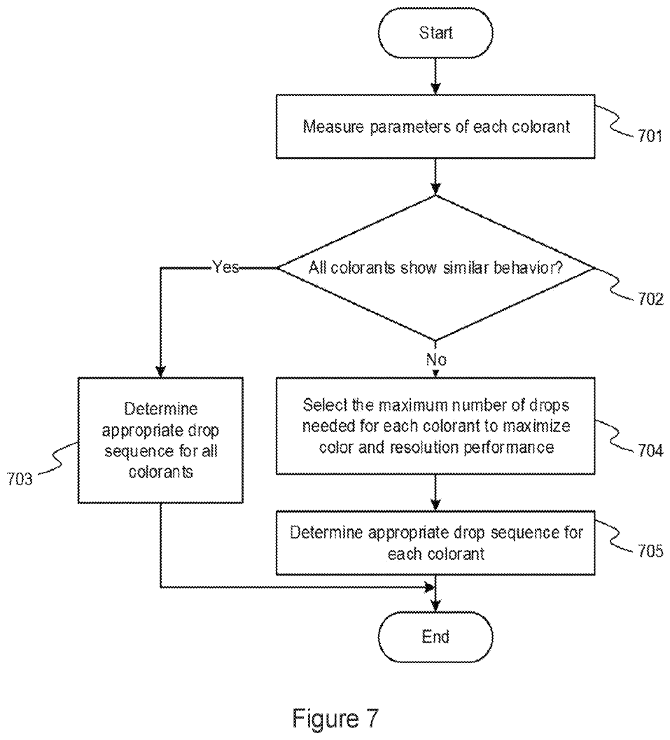

FIG. 7 shows a method for calculating drop sequences according to an example of the disclosure. The drop sequence for each colorant may be determined by the manufacturer of the colorant or print head, or may be set by the user. At 701 parameters of each colorant may be measured or otherwise determined. The parameters may be parameters of the colorant or colorant behavior, such as, for example, dot shape or size, chroma, lightness, or any other suitable parameters. The measurement or determination may find the number of drops to reach a maximum or optimal value of one or more of the parameters. At 702 it is determined if all the colorants have similar parameters or behavior according to the measurement. If so, then at 703, the same drop sequence may be selected for use with all colorants. If not, then at 705 the maximum number of drops needed for each colorant may be independently set to maximise color and resolution performance for that colorant, and at 706 an appropriate drop sequence is determined for each colorant. For example, if it is determined that a colorant reaches a maximum chroma using five drops, a drop sequence with a maximum of five drops may be selected or created for that colorant. If there is unbalanced behavior between two or more colorants then this indicates that different drop sequences for those colorants may be used. In some examples, the method may be performed automatically by the print head or associated equipment. For example, a printer may perform a calibration process to measure colorant parameters, or may obtain the parameters from the colorant manufacturer via a network connection, or from hardware or software provided with the colorant (e.g. from a memory of an ink cartridge). It will be appreciated that these are merely examples and that the method may be performed by the manufacturer of the print head, by a user, by any combination of these, or by any other suitable entities.

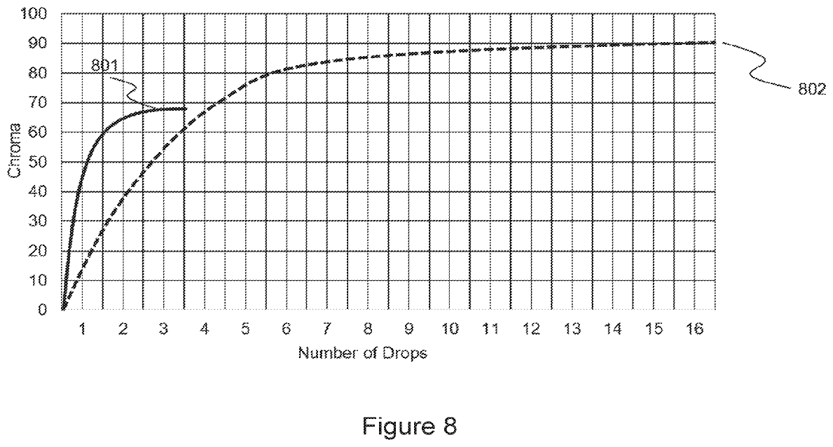

FIG. 8 shows a graph of chroma value against number of drops according to an example of the disclosure. The data 801 for the first colorant shows that a maximum chroma value is measured after three drops. A first drop sequence with a maximum of three drops may therefore be selected for the first colorant. The data 802 for the second colorant shows that a maximum chroma value is reached after sixteen drops. A second drop sequence with a maximum of sixteen drops may therefore be selected for the second colorant.

The example drop sequences described above all include a one-drop level. It will be appreciated that these are merely examples, and that a drop sequence may not include a one-drop level. For example, a drop sequence DS-2-6-10-14 could be used, mapping input color channel values to zero drops, two drops, six drops, ten drops, or fourteen drops. It will be appreciated that the levels between the minimum and maximum numbers of drops may be evenly spaced, but may also be unevenly spaced, depending on the parameters of the colorant.

The term ‘colorant’ has been used above, but it will be appreciated that this term is intended to cover any printing liquid or substance, including black, white, or grey inks, metallic inks, fluorescent inks, invisible or transparent inks, 3D printing substances, or any other suitable inks, pigments, dyes, or glues. That is, the present application is applicable to any printing liquids or substances that are applied to a substrate in drops according to drop sequences. The substrate may be any suitable substrate, and may, for example, be a previously printed portion of a model or part in a 3D printing process.

The term ‘input color channel value’ has been used above, but it will be appreciated that this term is intended to cover any input suitable for indicating the amount of colorant that should be output. For example, the input color channel value may be a contone value.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants which fall within the scope of the claims.

What is claimed is:

1. A print head to transfer two or more colorants from respective reservoirs to a substrate according to respective drop sequences, each drop sequence defining a mapping between an input color channel value and an output number of drops of the colorant;
wherein a first drop sequence for a first colorant defines a different mapping to a second drop sequence for a second colorant.

2. The print head of claim 1, wherein each of the first and second drop sequences defines an output number of drops for a plurality of input color channel value ranges.

3. The print head of claim 1, wherein the first drop sequence defines a first maximum number of drops, and the second drop sequence defines a second maximum number of drops that is greater than the first maximum number of drops.

4. The print head of claim 3, wherein the first colorant is lighter than the second colorant.

5. A printing system comprising:
a print head to transfer two or more colorants from respective reservoirs to a substrate according to respective drop sequences, each drop sequence defining a mapping between an input color channel value and an output number of drops of the colorant;
a first reservoir to contain a first colorant, couple to the print head, and supply the first colorant to the print head; and
a second reservoir to contain a second colorant, couple to the print head, and supply the second colorant to the print head;
wherein a first drop sequence for the first colorant defines a different mapping to a second drop sequence for the second colorant.

6. A method comprising:
receiving a first input color channel value for a first colorant and a second input color channel value for a second colorant;
obtaining a first number of drops of a first colorant based on the first input color channel value and a first drop sequence; and
obtaining a second number of drops of a second colorant based on the second input color channel value and a second drop sequence;
wherein the first drop sequence defines a first mapping between input color channel values and number of drops and the second drop sequence defines a second, different, mapping between input color channel values and number of drops.

7. The method of claim 6, wherein each of the first and second drop sequences defines a plurality of levels, wherein each level defines an output number of drops for a range of input color channel values.

8. The method of claim 7, further comprising:
obtaining, if the first number of drops does not match a number of drops corresponding to one of the levels of the first drop sequence, a first proportion of pixels using a number of drops corresponding to a first level of the first drop sequence and a second proportion of pixels using a number of drops corresponding to a second level of the first drop sequence such that the average number of drops per pixel in the first and second proportions of pixels corresponds to the first number of drops; and
obtaining, if the second number of drops does not match a number of drops corresponding to one of the levels of the second drop sequence, a third proportion of pixels using a number of drops corresponding to a third level of the second drop sequence and a fourth proportion of pixels using a number of drops corresponding to a fourth level of the second drop sequence such that the average number of drops per pixel in the third and fourth proportions of pixels corresponds to the second number of drops.

9. The method of claim 6, wherein the first drop sequence defines a first maximum number of drops, and the second drop sequence defines a second maximum number of drops that is greater than the first maximum number of drops.

10. The method of claim 9, wherein the first colorant is lighter than the second colorant.

11. A non-transitory machine readable storage medium encoded with instructions executable by a processor, the machine readable storage medium comprising:
instructions to use a first drop sequence to convert a first input color channel value to a first output number of drops for a first colorant;
instructions to use a second drop sequence to convert a second input color to a second output number of drops for a second colorant;
wherein the first drop sequence defines a first mapping between input color channel values and number of drops and the second drop sequence defines a second, different, mapping between input color channel values and number of drops.

12. The non-transitory machine readable storage medium of claim 11, wherein each of the first and second drop sequences defines a plurality of levels, wherein each level defines an output number of drops for a range of input color channel values.

13. The non-transitory machine readable storage medium of claim 12, further comprising:
instructions to obtain, if the first number of drops does not match a number of drops corresponding to one of the levels of the first drop sequence, a first proportion of pixels using a number of drops corresponding to a first level of the first drop sequence and a second proportion of pixels using a number of drops corresponding to a second level of the first drop sequence such that the average number of drops per pixel in the first and second proportions of pixels corresponds to the first number of drops; and
instructions to obtain, if the second number of drops does not match a number of drops corresponding to one of the levels of the second drop sequence, a third proportion of pixels using a number of drops corresponding to a third level of the second drop sequence and a fourth proportion of pixels using a number of drops corresponding to a fourth level of the second drop sequence such that the average number of drops per pixel in the third and fourth proportions of pixels corresponds to the second number of drops.

14. The non-transitory machine readable storage medium of claim 11, wherein the first drop sequence defines a first maximum number of drops, and the second drop sequence defines a second maximum number of drops that is greater than the first maximum number of drops.

15. The non-transitory machine readable storage medium of claim 14, wherein the first colorant is lighter than the second colorant.
